(19) United States
(12) Patent Application Publication
(10) Pub. No.: US 2023/0162876 A1
(43) Pub. Date: May 25, 2023

(54) SYSTEM FOR CONFINING AND COOLING MELT FROM THE CORE OF A NUCLEAR REACTOR

(71) Applicants: JOINT-STOCK COMPANY "ATOMENERGOPROEKT", Moscow (RU); SCIENCE AND INNOVATIONS - NUCLEAR INDUSTRY SCIENTIFIC DEVELOPMENT, PRIVATE ENTERPRISE, Moscow (RU)

(72) Inventors: ALEKSANDR STALEVICH SIDOROV, Moscow (RU); KRISTIN ALEKSANDROVIC CHIKAN, Moscow (RU); NADEZHDA VASILIEVNA SIDOROVA, Moscow (RU)

(73) Assignees: JOINT-STOCK COMPANY "ATOMENERGOPROEKT", Moscow (RU); SCIENCE AND INNOVATIONS - NUCLEAR INDUSTRY SCIENTIFIC DEVELOPMENT, PRIVATE ENTERPRISE, Moscow (RU)

(21) Appl. No.: 17/619,127

(22) PCT Filed: Dec. 29, 2020
(86) PCT No.: PCT/RU2020/000765

§ 371 Date: Dec. 14, 2021

(30) Foreign Application Priority Data
Mar. 18, 2020 (RU) 2020111299

(51) Int. Cl. G21C 9/016

(52) U.S. Cl. CPC G21C 9/016

(57) ABSTRACT

The invention relates to the field of nuclear energy, in particular, to systems that ensure the safety of nuclear power plants (NPP), and can be used in severe accidents that lead to reactor pressure vessel and its containment destruction.

The technical result of the claimed invention consists in increasing the reliability of the corium localizing and cooling system of the nuclear reactor, increase of heat removal efficiency from corium of the nuclear reactor.

The technical result is achieved by using upper heat insulation in the corium localizing and cooling system of the nuclear reactor, installed in the area between the reactor pressure vessel and cantilever truss, and lower thermal protection installed inside the reactor pressure vessel on the filler upper cassette.

### TECHNICAL FIELD OF THE INVENTION

The invention relates to the field of nuclear energy, in particular, to systems that ensure the safety of nuclear power plants (NPP), and can be used in severe accidents that lead to reactor pressure vessel and its containment destruction.

The accidents with core meltdown, which may take place during multiple failure of the core cooling system, constitute the greatest radiation hazard.

During such accidents the core melt—corium—by melting the core structures and reactor pressure vessel escapes outside its limits, and the afterheat retained in it may disturb the integrity of the NPP containment—the last barrier in the escape routes of radioactive products to the environment.

To exclude this, it is required to localize the core melt (corium) escaping from the reactor pressure vessel and provide its continuous cooling up to its complete crystallization. The corium localizing and cooling system of the nuclear reactor performs this function, which prevents the damage of the NPP containment and thereby protects the public and environment against exposure effect during severe accidents of the nuclear reactors.

### PRIOR ART

The corium localizing and cooling system [1] of the nuclear reactor containing the guide plate installed under the reactor pressure vessel and resting on the cantilever truss, installed in the embedded parts in the foundation of the concrete pit of the layered vessel, flange thereof is equipped with thermal protection, filler consisting of a set of cassettes installed on each other, service platform, installed inside the reactor pressure vessel between the filler and guide plate.

This system in accordance with its design features has the following disadvantages, namely:
at the moment of melt-through (destruction) of the reactor pressure vessel by corium in the formed aperture under the impact of residual pressure available in the reactor pressure vessel, the overheated melt begins to flow distributing non-symmetrically inside the volume of the layered vessel that is accompanied by dynamic contacts of the melt with peripheral structures leading to damage of the peripheral structures and equipment installed on the flange of the layered vessel;
on jet intake of overheated melt by large flow inside the layered vessel to the filler as result of repelling effect on the part of the filler a part of the overheated melt is displaced in the reverse direction towards the peripheral structures and layered vessel with water supply valves installed (WSV) on it that leads to their damage and destruction;
on flow of melt inside the layered vessel into the filler a melt level is formed, and fall of core fragments and reactor vessel head shall lead to the formation of splashes (waves) of melt capable of damaging the peripheral equipment and WSV installed in the layered vessel;
aerosols are formed in the outflow process of corium from the reactor pressure vessel and on interaction with the filler, which displace to the top from the hot areas and settling in the cold areas on the peripheral equipment and on WSV that leads to damage of peripheral equipment and WSV installed in the layered vessel;
after intake of corium inside the layered vessel premature water supply inside the layered vessel is possible due to premature melt-through of WSV, as a result of which excessive high pressure gas generation may take place that shall lead to explosion and damage of the corium localizing and cooling system.

The corium localizing and cooling system of the nuclear reactor containing the guide plate installed below the reactor pressure vessel and resting on the cantilever truss, installed in the embedded parts in the foundation of the concrete cavity of the layered vessel, flange thereof is equipped with thermal protection, filler consisting of set of cassettes installed on each other, service platform installed inside the pressure vessel between the filler and guide plate is known.

This system in accordance with its design features has the following disadvantages, namely:
at the moment of melt-through (destruction) of the reactor pressure vessel by corium in the formed aperture under the impact of residual pressure available in the reactor pressure vessel, the overheated melt begins to flow distributing non-symmetrically inside the volume of the layered vessel that is accompanied by dynamic contacts of the melt with peripheral structures leading to damage of the peripheral structures and equipment installed on the flange of the layered vessel;
on jet intake of overheated melt by large flow inside the multi-layered vessel to the filler following repelling effect on the part of the filler a part of the melt is displaced in the reverse direction towards the peripheral structures and layered vessel with WSV installed in it that leads to their surface and structural damage.
on flow of melt inside the layered vessel into the filler a melt level is formed, and fall of core fragments and reactor vessel head shall lead to the formation of splashes (waves) of melt capable of damaging the peripheral equipment and WSV installed in the layered vessel;
aerosols are formed in the outflow process of corium from the reactor pressure vessel and on interaction with the filler, which displace to the top from the hot areas and settling in the cold areas on the peripheral equipment and on WSV that leads to damage of peripheral equipment and WSV installed in the layered vessel;
after intake of corium inside the layered vessel premature water supply inside the layered vessel is possible due to premature melt-through of WSV, as a result of which excessive high pressure gas generation may take place that shall lead to explosion and damage of the corium localizing and cooling system.

The corium localizing and cooling system [3] of the nuclear reactor containing the guide plate installed under the nuclear reactor pressure vessel, and resting on the cantilever truss, installed in the embedded parts in the foundation of the concrete pit of the layered vessel, flange thereof is equipped with thermal protection, filler, consisting of set of cassettes installed on each other, each of them contains one central and several peripheral apertures, water supply valves installed in the branch pipes located along the perimeter of the layered vessel in the area between the upper cassette and flange, service platform installed inside the layered vessel between the filler and guide plate is known.

This system in accordance with its design features has the following disadvantages, namely:
at the moment of melt-through (destruction) of the reactor pressure vessel by corium in the formed aperture under the impact of residual pressure available in the reactor pressure vessel, the overheated melt begins to flow distributing non-symmetrically inside the volume of the layered vessel that is accompanied by dynamic contacts of the melt with peripheral structures leading to damage of the peripheral structures and equipment installed on the flange of the layered vessel;
on jet intake of overheated melt by large flow inside the multi-layered vessel to the filler following repelling effect on the part of the filler a part of the melt is displaced in the reverse direction towards the peripheral structures and layered vessel with WSV installed in it that leads to their surface and structural damage.
on flow of melt inside the layered vessel into the filler a melt level is formed, and fall of core fragments and reactor vessel head shall lead to the formation of splashes (waves) of melt capable of damaging the peripheral equipment and WSV installed in the layered vessel;
aerosols are formed in the outflow process of corium from the reactor pressure vessel and on interaction with the filler, which displace to the top from the hot areas and settling in the cold areas on the peripheral equipment and on WSV that leads to damage of peripheral equipment and WSV installed in the layered vessel;
after intake of corium inside the layered vessel premature water supply inside the layered vessel is possible due to premature melt-through of WSV, as a result of which excessive high pressure gas generation may take place that shall lead to explosion and damage of the corium localizing and cooling system.

### DISCLOSURE OF THE INVENTION

The technical result of the claimed invention consists in increasing the reliability of the corium localizing and cooling system of the nuclear reactor, increase of heat removal efficiency from corium of the nuclear reactor.

The tasks for resolving thereof the claimed invention is directed are the following:
provision of protection of peripheral structures and equipment installed on the flange of the multi-layered vessel, against damage in the process of nonaxisymmetrical outflow of the overheated corium from the reactor pressure vessel;
provision of protection of the peripheral structures and WSV against damage following repelling effect on the part of the filler wherein a part of the overheated melt is displaced in the reverse direction towards the peripheral structures and WSV;
provision of protection of peripheral structures and WSV against damage following splashes (waves) of melt on fall of core fragments and fragments of reactor pressure vessel head into the corium bath.
providing protection of peripheral structures and WSV against damage following settlement of aerosols and their subsequent collapse together with the parts of equipment into the corium bath;
providing protection of equipment against damage during premature water supply inside the layered vessel during premature melt-through of WSV;
providing protection (thermal shielding) of WSV, installed along the perimeter of layered vessel against thermal radiation on the part of the corium mirror.

The assigned tasks are resolved due to the fact that corium localizing and cooling of the nuclear reactor containing the guide plate (1) installed below the vessel (2) of the nuclear reactor and resting on the cantilever truss (3) installed in the embedded parts in the foundation of the concrete pit of the layered vessel (4) designed for intake and distribution of corium, flange (5) thereof is equipped with thermal protection (6), filler (7) comprising of several cassettes (8) installed on each other, each of them contains one central and several peripheral holes (9), water supply valves (10) installed in the branch pipes (11), located along the perimeter of the layered vessel (4) in the area between the upper cassette (8) and flange (5), in accordance with the invention inside the layered vessel (4) an upper thermal protection (15) is additionally installed consisting of the external (21), internal (24) shells and head (22), suspended to the flange (28) of the cantilever truss (3) through heat resistant fasteners (19) installed in the heat insulating flange (18) with contact interflange gap (29) between the heat insulating flange (18) and flange (28) of the cantilever truss and covering upper part of the thermal protection (6) of the flange (5) of the layered vessel (4), provided that the space between the external shell (21), internal shell (24) and head (22) is filled with melting concrete (26), separated into sectors by vertical ribs (20) and retained by the vertical (23), long radial (25) and short radial (27) reinforcement rods, besides the strength of the external shell (21) is above the strength of internal shell (24) and head (22), and separation elements (30) are executed in internal shell (24), lower thermal protection (12) is installed in the upper cassette (8), consisting of the external (14), internal (31) shells and head (13), contacting with the separation elements (30) of the lower part of the upper thermal protection (15), provided that in the lower part of the lower thermal protection (12) arched elements (17) are executed, which cover the thermal protection (6) of the flange (5) of the layered vessel (4), moreover the space between the external shell (14), internal shell (31) and head (13) is filled with slag forming concrete (33), divided into sectors by vertical ribs (32) and retained by vertical (34), long radial (35) and short radial (16) reinforcement rods, provided that the strength of the external load-bearing shell (14) is above the strength of the internal shell (31), head (13) and arched elements (17).

One of the essential feature of the claimed invention is the availability in the corium localizing and cooling system of the nuclear reactor of the upper thermal protection suspended to the cantilever truss and covering the upper part of thermal protection of the layered vessel flange with formation of slit-type gap, preventing direct impact action on the part of corium from the reactor pressure vessel in the leak-tight connection area of the layered vessel with cantilever truss. The upper thermal protection provides protection of peripheral structures and WSV against damage following repelling effect on the part of the filler, wherein a part of the overheated melt outflowing from the reactor pressure vessel is displaced in the reverse direction towards the peripheral structures and WSV, provides protection of the peripheral structures and WSV against damage following splashes (waves) of melt on fall of core fragments and fragments of the reactor pressure vessel into the corium pool.

One more essential feature of the claimed invention is the availability of lower thermal protection installed in the upper cassette in the corium localizing and cooling system of the nuclear reactor. The lower thermal protection consists of external, internal shells and head. The lower thermal protection contacts with the separation elements of the lower part of upper thermal protection, in the lower part thereof arched elements are executed covering the thermal protection of the layered vessel flange. The external shell is covered with layer of slag-forming concrete, divided into sectors by vertical ribs and retained by vertical, long radial and short radial reinforcement rods, and executed in such manner that its strength is above the strength of the internal shell, head and arched elements. The lower thermal protection provides thermal shielding of the water supply valves installed along the perimeter of the layered vessel against thermal radiation on the part of corium mirror, provides protection of peripheral structures and equipment installed on the flange of the multi-layered vessel against damage in the process of non-axisymmetrical outflow of overheated corium from the reactor pressure vessel, provided protection of peripheral structures and WSV against damage following the repelling effect on the part of the filler, wherein the overheated corium outflowing from the reactor pressure vessel is displaced in the reverse direction towards the peripheral structures and WSV, provides protection of peripheral structures and WSV against damage following splashes (waves) of corium on fall of core fragment and fragment of reactor pressure vessel head into the corium pool, provides protection of peripheral structures and WSV against damage following settlement of aerosols and their subsequent collapse together parts of equipment into the corium bath, provides equipment protection against damage on premature water supply inside the layered vessel during premature melt-through of WSV, provides protection (thermal shielding) of WSV, installed along the perimeter of layered vessel, against thermal radiation on the part of the corium mirror.

### BRIEF DESCRIPTION OF DRAWINGS

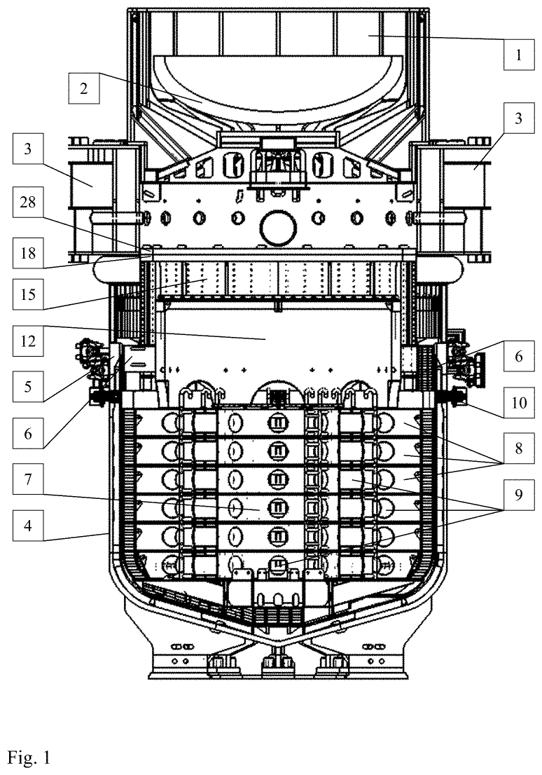

The corium localizing and cooling system of the nuclear reactor executed in accordance with the claimed invention is shown in FIG. 1.

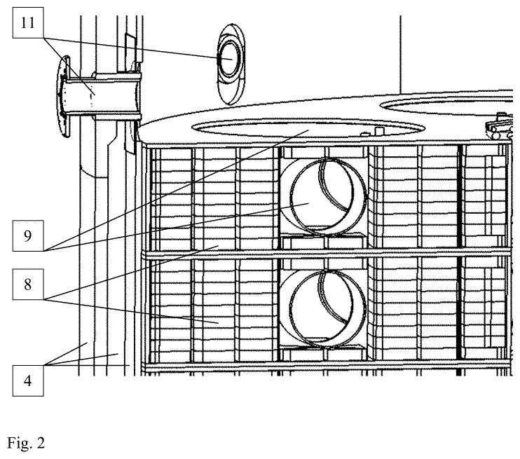

The area between the filler upper cassette and lower surface of the cantilever truss is shown in FIG. 2.

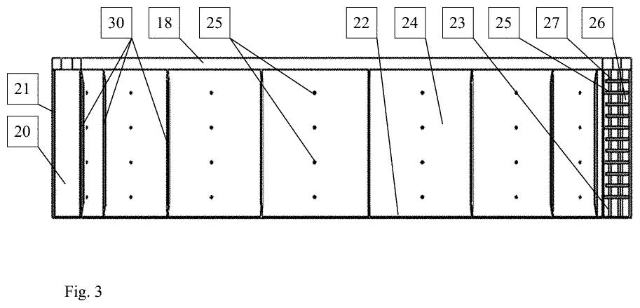

The general view of the upper heat insulation executed in accordance with claimed invention is shown in FIG. 3.

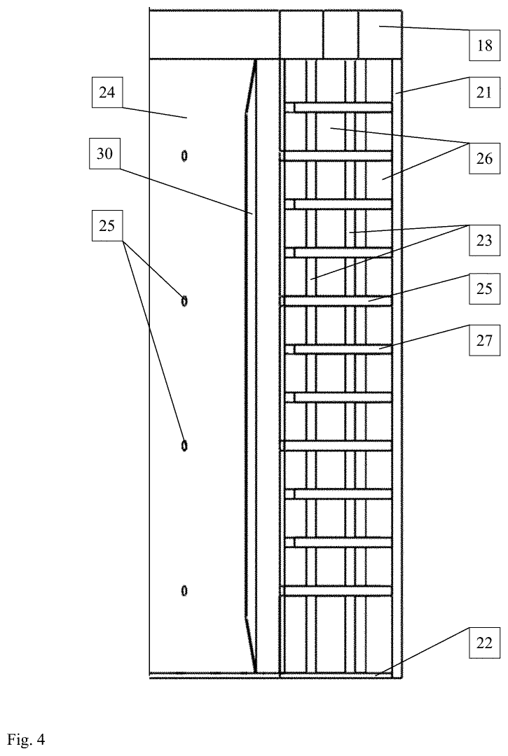

The fragment of the upper thermal protection in the context executed in accordance with the claimed invention is shown in FIG. 4.

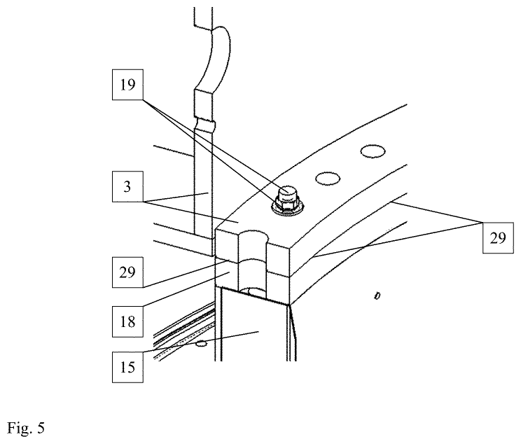

The fitting area of the upper thermal protection to the cantilever truss is shown in FIG. 5.

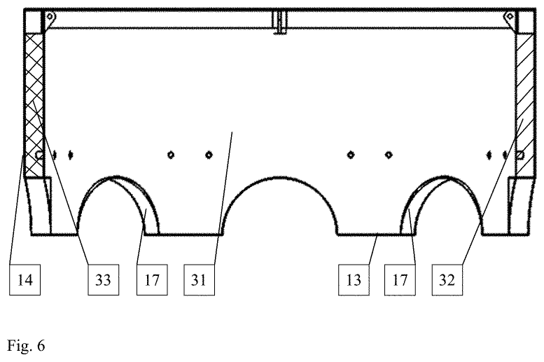

The general view of the lower thermal protection executed in accordance with the claimed invention is shown in FIG. 6.

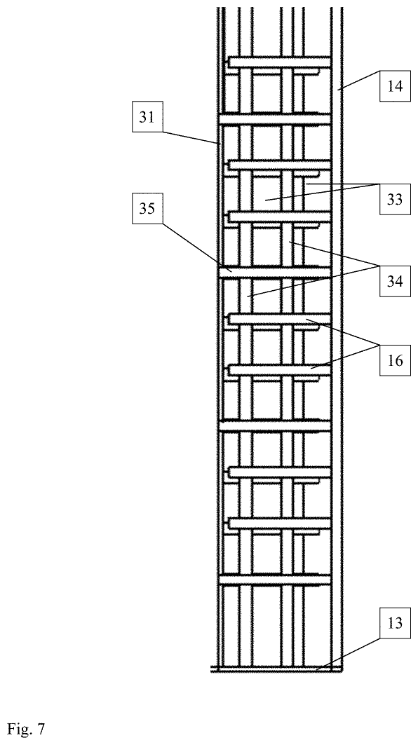

The fragment of the lower thermal protection in the context executed in accordance with the claimed invention is shown in FIG. 7.

### EMBODIMENTS OF THE INVENTION

As shown in FIGS. 1-7, the corium localizing and cooling system of the nuclear reactor comprises of the guide plate (1) installed below the reactor pressure vessel (2) and resting on the cantilever-truss (3). A layered vessel (4) is installed below the cantilever truss (3), which is installed in the foundation of the reactor pit on embedded parts. The layered vessel (4) is designed for corium intake and distribution. A flange (5) provided with thermal protection (6) is executed in the upper part of the layered vessel (4). A filler (7) is installed inside the layered vessel (4). The filler (7) consists of several cassettes (8) installed on one another, each containing one central and several peripheral holes (9). The water supply valves (10) installed in the branch pipes (11) are located in the area between the upper cassette (8) and flange (5) along the perimeter of the layered vessel (4). In addition, the upper thermal protection (15) is installed inside the layered vessel (4).

The upper thermal protection (15) comprises of external (21), internal (24) shells and head (22). The upper thermal protection (15) is suspended to the cantilever truss flange (28) by heat-resistant fasteners (19). The heat-resistant fasteners (19) are installed in the thermal insulating flange (18) with the formation of contact inter-flange gap (29) between the thermal insulating flange (18) and cantilever truss flange (28). The upper thermal protection (15) is installed in such manner that it covers the upper part of thermal protection (6)of the flange (5) of layered vessel (4) and lower part of the cantilever truss (3). The space between the external shell (21), internal shell (24) and head (22) is filled with melting concrete (26), which is divided into sectors by the vertical ribs (20). In addition, the melting concrete is retained by vertical (23), long radial (25) and short radial (27) reinforcement rods. In this case, the strength of the external barrier (21) is above the strength of the internal barrier (24) and head (22), and separation elements (30) are executed in the internal barrier (24).

The lower thermal protection (12) consisting of the external (14), internal (31) barriers and head (13) is installed on the upper cassette (8). The lower thermal protection contact with the separation elements (30) of the lower part of the upper thermal protection (15). Arched elements are executed in the lower part of the lower thermal protection (12), which on installation in the layered vessel (4) with its lower part cover the water supply valve (10) against direct impact on the part of overheated melt, and with its upper part provide unconstrained intake of overheated melt into the hole (9) of the cassettes (8).

The space between the external shell (14), internal shell (31) and head (13) has been filled with slag forming concrete (33), divided into sectors by vertical ribs (32) and retained by vertical (34), long radial (35) and short radial (16) reinforcement rods. The strength of the external shell (14) is above the strength of the internal shell (31), head (13) and arched elements (17).

The claimed corium localizing and cooling system of the nuclear reactor according to the claimed invention operates as follows.

At the time of nuclear reactor pressure vessel (2) damage the corium under the action of hydrostatic and residual pressures begins to enter on the guide plate (1) surface, retained by the cantilever truss (3). The melt, running down along the guide plate (1) enters the layered vessel (4) and enters into contact with the filler (7). During sectoral non-axisymmetrical run down of the melt flashing of the thermal protections take place of the cantilever truss (3), thermal protection (6) of the flange (5) of the layered vessel (4), upper (15) and lower (12) thermal protections. By disintegrating these thermal protections on the one part reduce thermal action of corium on the protected equipment, on the other part reduce the temperature and chemical activity of the melt itself

Thermal protection (6) of the flange (5) of the layered vessel (4) provides protection of its upper thick-walled internal part against thermal action on the part of the corium mirror from the time of melt intake into the filler (7) and to the end of interaction of melt with the filler (7), i.e. to the start time of cooling of the clinker located on the corium surface with water. The thermal protection (6) of the flange (5) of the multi-layered vessel (4) is installed in such manner that allows provide protection of the internal surface of the multi-layered vessel (4) above the corium level formed in the layered vessel 94) in the interaction process with the filler (7), in particular by that upper part of the layered vessel (4) providing normal (without heat exchange crisis in boiling mode in large quantity) heat transfer from corium to water present on the external side of the layered vessel (4).

The thermal protection (6) of the flange (5) of the layered vessel (4) in the process of interaction of the corium with the filler (7) is subject to heating and partial disintegration, by shielding heat insulation on the part of melt mirror. The geometrical and thermal and physical characteristics of thermal protection (6) of the flange (5) of the layered vessel (4) are selected in such manner that at any conditions shielding of the flange (5) of the layered vessel (4) is provided on the part of corium minor thanks to which in turn the independence of protective functions from completion time of the physical and chemical interaction processes of corium with the filler (78) is provided. Thus, the availability of thermal protection (6) of the flange 95) of the layered vessel (4) allows provide perform the protective functions before the start of water supply to the crust located on the corium surface.

As shown in FIG. 1, 3, 4, the upper thermal protection (15), suspended to the cantilever truss (3) is above the upper level of thermal protection (6) of the flange (5) of the layered vessel (4), it covers the upper part of thermal protection (6) of the flange (5) of the layered vessel (4) with its lower part providing protection against the impact of thermal radiation on the part of corium minor not only of the lower part of the cantilever truss (3) but the upper part of the thermal protection 96) of the flange 95) of the multi-layered vessel 94). The geometrical characteristics such as the distance between the external surface of the upper thermal protection (15) and internal surface of thermal protection (6) of the flange (5) of the multi-layered vessel (4), and height of the covering of the specified thermal protections (15 and 6) have been selected in such manner to provide the absence of damages of the upper part of thermal protection (6) of the flange (5) of the multi-layered vessel (4) that provides its mechanical stability, consequence thereof being the protection above the water supply valves (10) against direct interaction on the part of overheated melt and flying objects.

As shown in FIG. 3, 4 in terms of design the upper thermal protection (15) consists of the external (21), internal (24) shells and head (22). As shown in FIG. 5, the upper thermal protection (15) is suspended to the flange (28) of the cantilever truss (3) by heat-resistant fasteners (19). The heat-resistant fasteners (19) are installed in the thermal insulating flange (18) with the formation of contact inter-flange gap (29) between the thermal insulating flange (18) and cantilever truss flange (28). The upper thermal protection (15) has been installed in such manner that it covers the upper part of thermal protection (6) of the flange (5) of the layered vessel (4) and lower part of the flange (28) of the cantilever truss. The space between the external shell (21), internal shell (24) and head (22) is filled with melting concrete (26). In addition, the melting concrete (26) is retained by vertical (23), long radial (25) and short radial(27) reinforcement rods. In this case, the strength of the external barrier (21) is above the strength of the internal barrier (24) and head (22), and separation elements (30) are executed in the internal barrier (24).

As shown in FIG. 6, 7, in terms of design the lower thermal protection (12) consists of the external (14), internal (31) shells and head (13). As shown in FIG. 4, the lower thermal protection (12) contacts with the separation elements (30) of the lower part of the upper thermal protection (15). As shown in FIG. 6, in the lower part of the lower thermal protection (12) arched elements (17) are executed, which when installed in the layered vessel (4) covers the thermal protection (6) of the flange (5) of the layered vessel (4). The space between the external shell (14), internal shell (31) and head (13) is filled with slag forming concrete (33), divided into sectors by vertical ribs (32) and retained by vertical (34), long radial (35) and short radial (16) reinforcement rods. In this case, the strength of the external shell (14) is above the strength of internal shell (31), head (13) and arched elements (17).

The lower thermal protection (12) provides thermal shielding of the water supply valves (10) installed along the perimeter of the layered vessel (4) in the area between the upper cassette (8) and filler (7) and flange 95) of the layered vessel (4) against impact of the thermal insulation on the part of corium mirror.

As shown in FIG. 1, the lower thermal protection (12) installed inside the layered vessel 94) rests on the upper cassette (8) of the filler (7) and covers the lower part of the upper thermal protection (15). Such a covering is provided by coaxial installation of the lower thermal protection (12) inside the upper thermal protection (15). The covering height and process gap between the lower and upper thermal protections (15 and 12) provide stable position of the upper thermal protection 915) on pulse pressure boost and impact non-axisymmetrical loading.

The arched elements (17) located at the base of lower thermal protection (12) provide opening of the full cross-section of the filler (7) holes (9) that allows redistribute air (gas) flows inside the filler (7) for quick leveling of pressure between the internal volumes of the multi-layered vessel (4) and redistribute the corium entering from the reactor pressure vessel (2).

The protection of water supply valves is made passively: lower thermal protection (12) is gradually dissolved (melted) in the corium as long as the melt interacts with the filler (7). This interaction is determined by the initial conditions of corium intake into the filler (7): on quick or slow intake of metal and oxide components of the melt.

On quick intake of metal and oxide components of the melt into the filler (7), wherein the delay in intake of oxide components is small, maximum 30 minutes (for example, on lateral melt-through of the reactor pressure vessel (2) and subsequent partial or complete disintegration of the reactor pressure vessel (2) head, the process of physical and chemical interaction is faster, density of oxide components of the corium relative to the density of metal components takes place quicker, inversion of melt takes place at an earlier stage, and as a consequence, formation of a single liquid melt pool in which the lower thermal protection (12) is dissolved (melted), by opening thermal radiation on the part of corium mirror to the water supply valves (10) that provides their heating and actuation for cooling water inlet.

On slow intake of metal and oxide components of corium into the filler (7), wherein the delay of oxide components intake exceeds 30 minutes (for example, during lateral melt-through of reactor pressure vessel (2), wherein the molten steel outflows first through the hole formed in the reactor pressure vessel (2), and then with the vessel melt-through liquid oxides outflow), the process of physical and chemical interaction takes place slower, and the reduction of density of oxide components of corium takes place slower relative to the density of metal components, and corium inversion takes places at a later stage, as a consequence formation of a single liquid corium pool in which the lower thermal protection(12) is dissolved (melted), opening access to the water supply valves (10) to thermal radiation on the part of the corium mirror that provides its heating and actuation for passing of cooling liquid.

The quick and slow intake of metal and oxide components of the corium into the filler (7) shall lead to considerable difference of attaining same states of corium in the multi-layered vessel (4) in time, hence the use of thermal shield, i.e. soluble in the corium of lower thermal protection (12) provides the actuation of water supply valves (10) at that time when the corium independent of the intake scenarios into the filler (7) shall have same thermal and chemical and mechanical state, safe for cooling the cake formed on the melt surface with water. Geometrical and thermal and physical characteristics of the lower thermal protection (12) are selected based on the guaranteed completion of the processes of physical and chemical interaction of corium with the filler (7) independent of the rate of this interaction.

The dual mode displacement described above of the lower thermal protection (12) related to the processes of collapse (melting, dissolving and chemical interaction) in corium formed by the components of the corium with sacrificial materials of the filler (7) is provided by different amount of energy required for collapse of each flat layer of the lower thermal protection (12).

Due to the presence of arched elements (17) in the lower part of the lower thermal protection (12) of the flat layer area in the lower part is considerably less than in the upper, hence the amount of energy spent for melting (disintegrating) the lower part shall be lesser than for the upper part layer. In this case the rate of lowering into the melt of the lower part of the lower thermal protection (12) made of arched elements (17) approximately is two times above the rate of lowering its upper part. Such a design of the lower thermal protection (12) allows at the initial interaction stage of corium with the filler (7) and lower thermal protection (12) provide quick impact-less covering of the sections of internal surface of the multi-layered vessel (4) against the impact of thermal radiation on the part of the corium mirror that allows block the direct radiation heat exchange between the corium mirror and internal surface of the multi-layered vessel (4).

In design position the operational elements of the water supply valves (10) are closed against direct radiation heat exchange by the arched elements (17) of the lower thermal protection (12) from the time when corium is inside the filler 97) and cassettes (8) had not lost the load-bearing capacity, to the time of formation of the melt mirror and start of shape change of the filler (7).

The arched elements (17) of the lower thermal protection (12) protect the operating elements of water supply valves (10) against the following direct and indirect actions:
against impact by re-radiation from neighboring sections of the internal cylindrical surface of the layered vessel (4);
against the action by thermal radiation on the part of melt mirror band, area thereof is limited by the inner diameter of the layered vessel 94), the external diameter of lower thermal protection (12) and net area of arched elements (17). In this case the thermal radiation acts on the lower end surface of thermal protection (6) of the flange (5) of the layered vessel (4), and re-radiation on the operating elements of the water supply valves (10) is possible without covering the circular arches by immersing the lower thermal protection (12) in the melt;
against direct impact of melt jet on impact and repelling from the surfaces of thermal protections (15 and 12);
against direct impact of the melt splashes on fall of the reactor equipment fragments into the melt;
against direct impact of melt jet on sectoral melt-through of thermal protections (15 and 12) in the guide plate (1) and service platform;
against impacts on the part of core equipment fragments and nuclear reactor pressure vessel (2).

In order that the lower thermal protection (12) on melting in the corium lowered into the melt without lugs, complete fusion and with minimum dynamic impact on the equipment of corium localizing and cooling system the following was executed:
outer wall of the lower thermal protection (12) is executed in the form of shell (14) providing the required strength and shape stability due to shadow arrangement with respect to impact of radiant heat fluxes;
small slit-type gap between the external shell (14) of the lower thermal protection (12) and upper thermal protection (15) before the melting of arched elements (17) provides minimum impact of convective heat exchange on the part of vapor-gas medium above the surface of melt mirror, for heating the external shell (14) of the lower thermal protection (12), and after melting of the arched elements (17) and lowering of the lower part of the lower thermal protection (12) into the melt the influence of reverse convective heat flux directed from top to bottom, on the part of the lower thermal protection (12) flange, for additional heating of the external shell (14) is not significant;
vertical ribs (20) of the upper thermal protection (15) have been executed with allowance inside in such manner that form vertical guides for sliding of the external shell (14) of the lower thermal protection (12) on them. This allows the lower thermal protection (12) in the melting process to lower into the melt along the vertical ribs (20) of the upper thermal protection (15) with minimum friction resistance;
process gap between the external shell (14) of the lower thermal protection (12) and vertical ribs (20) of the upper thermal protection (15) and provides contact of thermal protections (15 and 12) only along several vertical ribs (20) that is provided by the sizes of process gap a little larger than the difference between the change of internal diameters of the upper thermal protection (15) and change of the external diameter of lower thermal protection (12) on thermal expansions at temperatures close to temperature of strength loss of external shell (14) of the lower thermal protection (12). The process gap provides the exclusion of squeezing of the lower and upper thermal protections (15 and 12) in the heating process.
small slit-type gap between the lower part of the upper thermal protection (15) and upper part of thermal protection (6) of the flange (5) of layered vessel (4) provides stability of the lower thermal protection (12) on its melting and displacement in the melt. Indirect mounting of the moving lower thermal protection (12) about the flange 95) of the layered vessel (4) through two thermal protections (15 and 6) installed with gaps with respect to each other excludes impact dynamic actions on the flange (5) of the layered vessel (4) on the part of the moving lower thermal protection (12) and excludes its seizure in the upper part of thermal protection (15) following the shape change of the latter. The form of the lower part of the upper thermal protection (12) is retained thanks to the impact of set, the role thereof is performed by the relatively colder upper part of thermal protection (6) of the flange (5) of the layered vessel 94).

Thus, the use of upper and lower thermal protections of the corium localizing and cooling system of the nuclear reactor installed inside the multi-layered vessel in the area of its joining with the cantilever truss allowed enhance its reliability due to provision of the largest hydraulic resistance on movement of gas-vapor mixture from the inner volume of the multi-layered vessel in the space located in the area between the layered vessel and cantilever truss and standard shielding of water supply valves installed along the perimeter of the multi-layered vessel against thermal radiation on the part of the corium mirror.

Sources of information:

1. RF Patent No. 2576517, IPC G21C 9/016, priority dated Dec. 16, 2014;

2. RF Patent No. 2576516, IPC G21C 9/016, priority dated Dec. 16, 2014;

3. RF Patent No. 2696612, IPC G21C 9/016, priority dated Dec. 26, 2018.

1. A corium localizing and cooling system of a nuclear reactor comprising of the guide plate (1) installed under the nuclear reactor pressure vessel (2) and resting on the cantilever truss (3), installed on the embedded parts at the base of the concrete pit of the layered reactor pressure vessel (4) designed for receipt and distribution of corium, flange (5) which is provided with thermal protection (6), filler (7), consisting of several cassettes installed on each other (8), each of them contains one central and several peripheral apertures (9), water supply valves (10), installed in the branch pipes (11), located along the perimeter of the multi-layered casing (4) in the area between the upper cassette (8) and flange (5), characterized in that inside the multi-layered casing (4) an upper thermal protection (15) is installed in addition, comprising of the external (21), internal (24) shells and head (22), internal (24) shells and head (22), suspended to the flange (28) of the cantilever truss (3) by means of heat resistant fittings (19), installed in the heat insulating flange (18) with contact interflange gap (29) between the heat insulating flange (18) and flange (28) of the cantilever truss and covering the upper part of the thermal protection (6) of the flange (5) of the multi-layered casing (4), provided that the space between the external shell (21), head (22) and internal shell (24) is filled with floating concrete (26), separated into sectors by the vertical ribs (20) and retained by the vertical (23), long radial (25) and short radial (27) reinforcement rods, and executed in such manner that its strength is higher than the strength of the internal shell (24) and the head (22), and on the internal shell (24) separating elements (30) are executed, on the upper cassette (8) the lower thermal protection (12) is installed comprising of external (14), internal (31) shells and head (13), contacting with the distancing elements (30) of the lower part of the upper thermal protection (15), in the lower part thereof arched elements (17) are executed, covering the thermal protection (6) of the flange (5) of the multi-layered casing (4), provided that the space between the external (14), internal (31) shells and head (13) is filled with slag forming concrete (33), divided into sectors by the vertical ribs (32) and retained by the vertical (34), long radial (35) and short radial (16) reinforcement rods, provided that the strength of the external shell (21) is above the strength of the internal shell 931), head (13) and arched elements (17).
